(19) United States
(12) Patent Application Publication
(10) Pub. No.: US 2026/0099516 A1
(43) Pub. Date: Apr. 9, 2026

(54) LLM-BASED CONTEXT SELECTION FOR A USER REQUEST

(71) Applicant: SAP SE, Walldorf (DE)

(72) Inventors: Felix SCHUBERT, Heidelberg (DE); Georgi Savov DAMYANOV, Chepelare (BG); Martin HAEUSER, Weinstrasse (DE); Andreas KUNZ, Karlsruhe (DE)

(21) Appl. No.: 18/907,969

(22) Filed: Oct. 7, 2024

(51) Int. Cl. G06F 16/332

(52) U.S. Cl. CPC G06F 16/3329

(57) ABSTRACT

A system may include a user data store containing items, each item containing an item identifier. The items might comprise, for example, files and file names arranged in a hierarchy. A context enhancement platform may then receive a user request from a user device. The context enhancement platform constructs and outputs a first Large Language Model (“LLM”) query, from a context selector to a first LLM. The first LLM query may be, for example, designed to select relevant items from the user data store. Based on a response to the first LLM query, the context enhancement platform constructs and outputs a second LLM query, from a prompt generator to a second LLM. The second LLM query may, according to some embodiments, include information about the user request and information about the relevant items.

### BACKGROUND

A Large Language Model (“LLM”) may be used to achieve general-purpose language generation and other natural language processing processes. Based on language models, LLMs acquire these abilities by learning statistical relationships from substantial amounts of text (e.g., from a knowledge base) during a training process. LLMs can be used for generative Artificial Intelligence (“AI”) by taking an input text or prompt and predicting future tokens or words using artificial neural networks. In some cases, an LLM may respond to user request in various contexts by referencing relevant knowledge sources. For example, a user may ask an LLM to suggest software code that will perform a particular function, in which case the LLM may review an existing program and suggest new lines of code.

To provide the relevant information to the LLM, a prompt might include all of the files associated with the original program. This might be a substantial amount of information which can be expensive and/or result in the LLM failing to correctly perform the task (e.g., due to losing focus due to the substantial amount of context). Moreover, some LLMs have a maximum limit capping the number of context tokens that are allowed to be submitted. One solution to these problem is to only send a file that a user is currently looking at to the LLM. However, many tasks will require changes to multiple files associated with a software program. As another solution, the system might only send the files that a user currently has open (the “open tabs”) to the LLM. This, however, may result in the user needing to remember which files should be opened (or closed) before submitting a request.

It would therefore be desirable to provide an AI framework that enhances context selection in a secure, automatic, and efficient manner.

### SUMMARY

According to some embodiments, methods and systems associated with an Artificial Intelligence (“AI”) framework may include a user data store containing items, each item containing an item identifier. The items might comprise, for example, files and file names arranged in a hierarchy. A context enhancement platform may then receive a user request from a user device. The context enhancement platform constructs and outputs a first Large Language Model (“LLM”) query, from a context selector to a first LLM. The first LLM query may be, for example, designed to select relevant items from the user data store. Based on a response to the first LLM query, the context enhancement platform constructs and outputs a second LLM query, from a prompt generator to a second LLM. The second LLM query may, according to some embodiments, include information about the user request and information about the relevant items.

Some embodiments comprise: means for receiving, at a computer processor of a context enhancement platform, a user request from a user device; means for constructing and outputting a first Large Language Model (“LLM”) query, from a context selector to an internal LLM, the first LLM query being designed to select relevant files names in a user data store, the user data store containing coding files with each file containing a file name; based on a response to the first LLM query, means for constructing and outputting a second LLM query, from a prompt generator to an external LLM, the second LLM query including information about the user request and information about the relevant coding files; and means for arranging for information about a response to the second LLM query to be transmitted to the user device.

Some technical advantages of some embodiments disclosed herein are improved systems and methods to provide an AI framework that enhances context selection in a secure, automatic, and efficient manner.

### BRIEF DESCRIPTION OF THE DRAWINGS

FIG. 1 is a high-level system architecture in accordance with some embodiments.

FIG. 2 is a method according to some embodiments.

FIG. 3 is an information flow in accordance with some embodiments.

FIG. 4 is a system associated with user requests to perform a software task according to some embodiments.

FIG. 5 is a method associated with user requests to perform a software task in accordance with some embodiments.

FIG. 6 is an information flow associated with user requests to perform a software task according to some embodiments.

FIG. 7 is a User Interface (“UI”) for an AI framework in accordance with some embodiments.

FIG. 8 is an end-to-end method according to some embodiments.

FIG. 9 is a system associated with a single LLM in accordance with some embodiments.

FIG. 10 is a system associated with multiple internal LLMs according to some embodiments.

FIG. 11 is an apparatus or platform according to some embodiments.

FIG. 12 is a portion of a user request database in accordance with some embodiments.

FIG. 13 illustrates a tablet computer AI framework display according to some embodiments.

FIG. 14 is a context enhancement operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

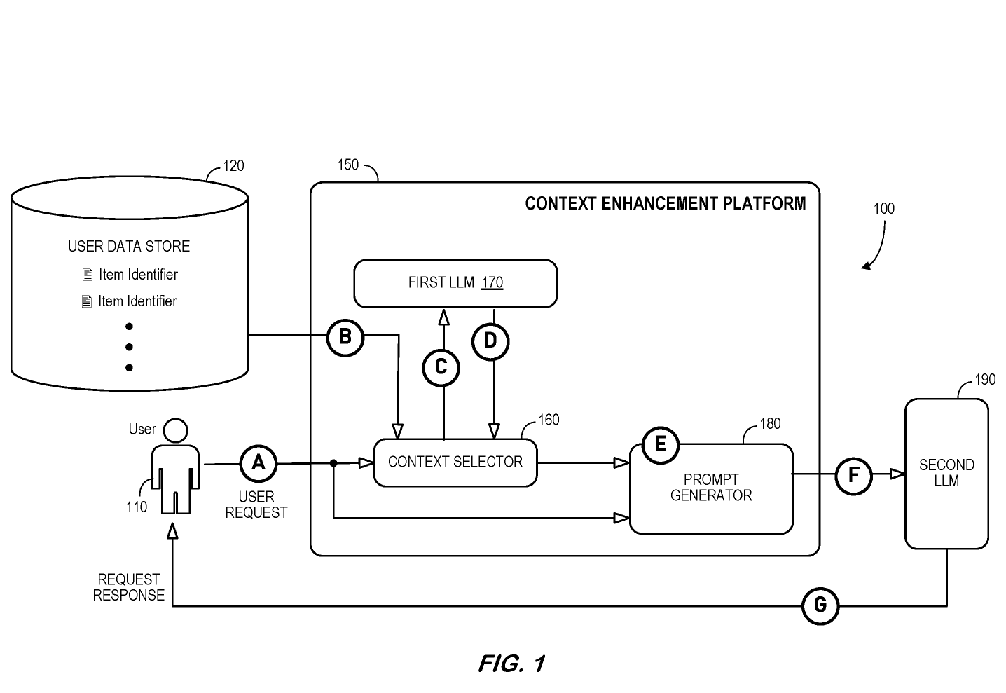

FIG. 1 is a high-level block diagram of one example of a system 100 architecture according to some embodiments. In particular, at (A) a context enhancement platform 150 may receive a user request from a user 110. The user request is associated with items stored in a user data store 120 (along with item identifiers). A context selector 160 receives the user request and determines information about items in the user data store 120 at (B). At (C), the context selector 160 creates a prompt based on the user request and information about the items in the user data store 120 (e.g., a list of item identifiers). The prompt to submitted to a first LLM 170 which responds with information about which items may be relevant to the user request at (D). This information is provided to a prompt generator 180 at (E) along with the user request. At (F), the prompt generator 180 constructs a prompt with the relevant context information and submits it to a second LLM 190. The second LLM 190 can then generate an appropriate response to the user request at (G). According to some embodiments, a remote operator or administrator device may be used to configure or otherwise adjust the system 100.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The context enhancement platform 150 may store information into and/or retrieve information from various data stores (e.g., the user data store 120), which may be locally stored or reside remote from the context enhancement platform 150. Although a single context enhancement platform 150 is shown in FIG. 1, any number of such devices may be included. Moreover, various devices described herein might be combined according to embodiments of the present invention. For example, in some embodiments, the user data store 120 and the context enhancement platform 150 might comprise a single apparatus. The system 100 functions may be performed by a constellation of networked apparatuses, such as in a distributed processing or cloud-based architecture. In some cases, the context enhancement platform 150 may process information associated with a number of different enterprises.

The system 100 may be accessed via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify how the elements connect with an enterprise computing environment infrastructure) and/or provide or receive automatically generated recommendations, alerts, summaries, or results associated with the system 100.

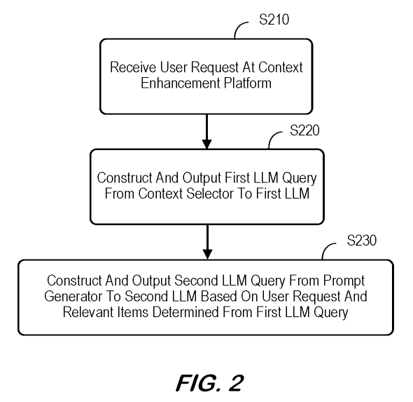

FIG. 2 is a method that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a computer processor of a context enhancement platform receives a user request from a user device. The user request might, for example, be a request to perform a software coding task (e.g., and the context enhancement platform may be associated with an AI coding assistant. Note that the term “user” might refer to a human (e.g., a software engineer) or an automated Artificial Intelligence (“AI”) agent.

At S220, a context selector constructs and outputs a first LLM query to an internal LLM. The first LLM query is designed to select relevant items in a user data store that contains items (with item identifiers). The items may be, for example, documents and the item identifiers are document titles. According to some embodiments, the documents comprise files and the document titles are file names. Moreover, the items in the user data store might be arranged in a hierarchy (e.g., folders and subfolders) and the first LLM query is further based on information about the hierarchy. For example, files could be arranged in various folders and subfolders for a developer platform that lets developers create, store, manage, and/or share code (e.g., GITHUB®). As another example, the user data store might contain a user table in which case the items may be portions of the user table (e.g., rows, columns, cells, etc.).

Based on a response to the first LLM query, at S230 a prompt generator constructs and outputs a second LLM query to an external LLM. The second LLM query includes information about the user request and information about the relevant items. In some embodiments, the second LLM query may be further based on a user selected code portion, user selected open code window tabs, a user request history, instructions about how the items interact, a requested output format, etc. In some embodiments, the first and second LLM comprise a single LLM. In other embodiments, the second LLM is a different model than, and independent of, the first LLM. For example, the first LLM might be internal to the context enhancement platform while the second LLM is external to the context enhancement platform. The system may then arrange for information about a response to the second LLM query to be transmitted to the user device.

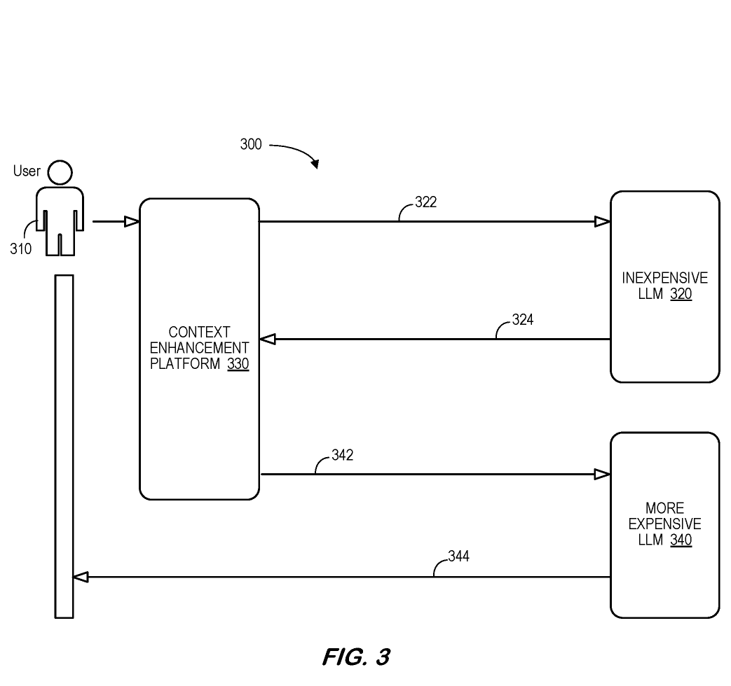

FIG. 3 is an information flow 300 in accordance with some embodiments. A user 310 provides a request to a context enhancement platform 330 which uses the request to create a prompt or query 322 for a relatively inexpensive LLM 320 (e.g., the CHAT GPT 3.5® LLM from OpenAI™). The query 322 is designed to select (from a user data store) the items that are most relevant to the user 310 request. The inexpensive LLM 320 provides a response 324 to query 322 listing the most relevant items. This is used by the context enhancement platform 330 to create a prompt 342, including the user 310 query and the list of most relevant items, that is sent to a more expensive LLM 340. A response 344 to that query can then be transmitted back to the user 310.

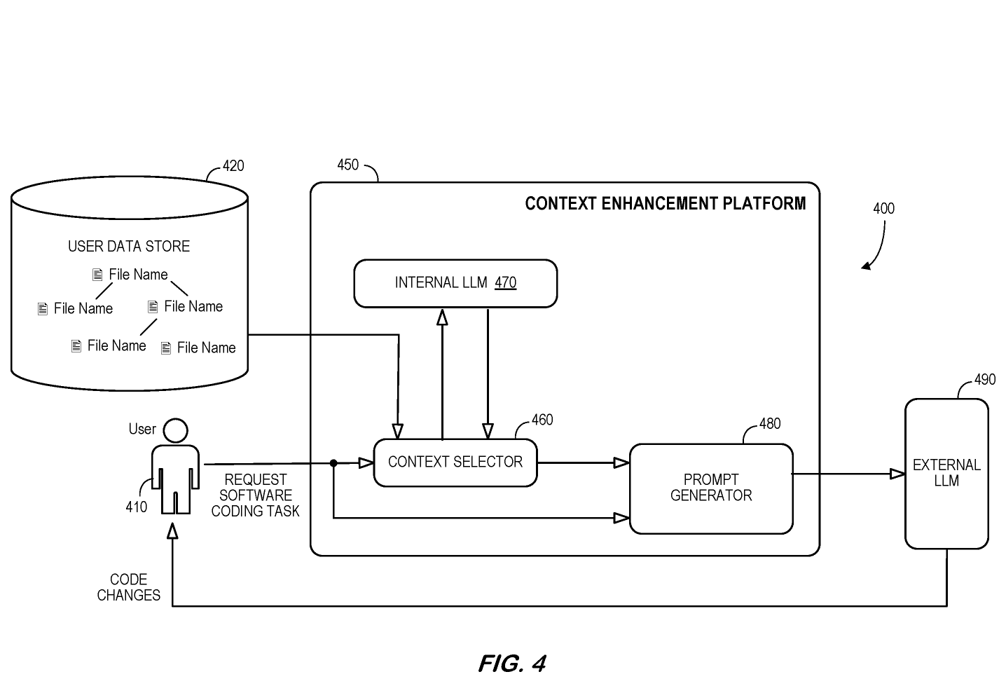

FIG. 4 is a system 400 associated with user requests to perform a software task according to some embodiments. As before, a context enhancement platform 450 receives a user request (a requesting a software coding task) from a user 410. The user request is associated with files stored in a user data store 420 (along with file names arranged in a file hierarchy). A context selector 460 receives the user request and determines information about files in the user data store 420. A prompt generator 480 creates a prompt based on the user request and information about the file in the user data store 420 (e.g., the list of file names and/or the file hierarchy). The prompt is then submitted to an internal LLM 470 which responds with information about which files are likely to be relevant to the user request. This information is provided to a prompt generator 480 along with the user request. The prompt generator 480 constructs a prompt with the relevant context information and submits it to an external LLM 490. The external LLM 490 can then generate an appropriate response to the user request.

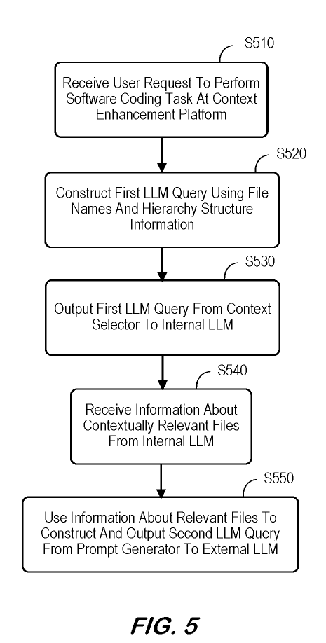

FIG. 5 is a method associated with user requests to perform a software task in accordance with some embodiments. Note that embodiments may benefit from the fact that in coding projects certain aspects are usually handled in specific files and file names are indicative of their content. As a result, an internal or relatively inexpensive LLM with broad training will typically find a good selection of relevant files based on the file names.

Consider, for example, a user request to “add a button to this page.” Before the actual LLM request that will request the codes changes, an initial request is sent to an LLM asking what files are needed to fulfill this particular user request. Based on the response, the content of the needed files is added as context to actual LLM call asking for the actual code modification. At S510, a user request to perform software coding task is received at a context enhancement platform (from a user device). At S520, the context enhancement platform constructs a first LLM query using the file names and/or hierarchy structure information.

By way of example, the user request may be analyzed, and a list of the files in a software project can be compiled based on that request and information in a user data store. In some embodiments, files may be filtered from this list. For example, files listed in a “.gitignore” table might be removed as not being relevant for a modification (and may even contain confidential information such as passwords). The LLM uses its general knowledge about programming together with the information provided in this first prompt to answer with the list of relevant files. As other examples: files typically containing confidential information such as “.env” may be removed; in a version-controlled code repository that holds many projects for an enterprise (e.g., a monorepos), only the code in the current sub-package might be considered (but this can be a configurable option); etc. Note that the format of the file list may help with reliable answers and other important information may be included.

At S530, the context enhancement platform outputs the first LLM query (e.g., from a context selector) to an internal LLM (e.g., internal to the context enhancement platform). That is, the request may be sent to an LLM that is good enough but as inexpensive as possible for this relatively simple task (e.g., the CHAT GPT 6.5® LLM from OpenAI™). At S540, the context enhancement platform receives information about contextually relevant files from the internal LLM. At S550, information about relevant files is used to construct and output a second LLM query from a prompt generator to an external LLM (e.g., external to the context enhancement platform). The response to this second LLM query can then be provided to the user device.

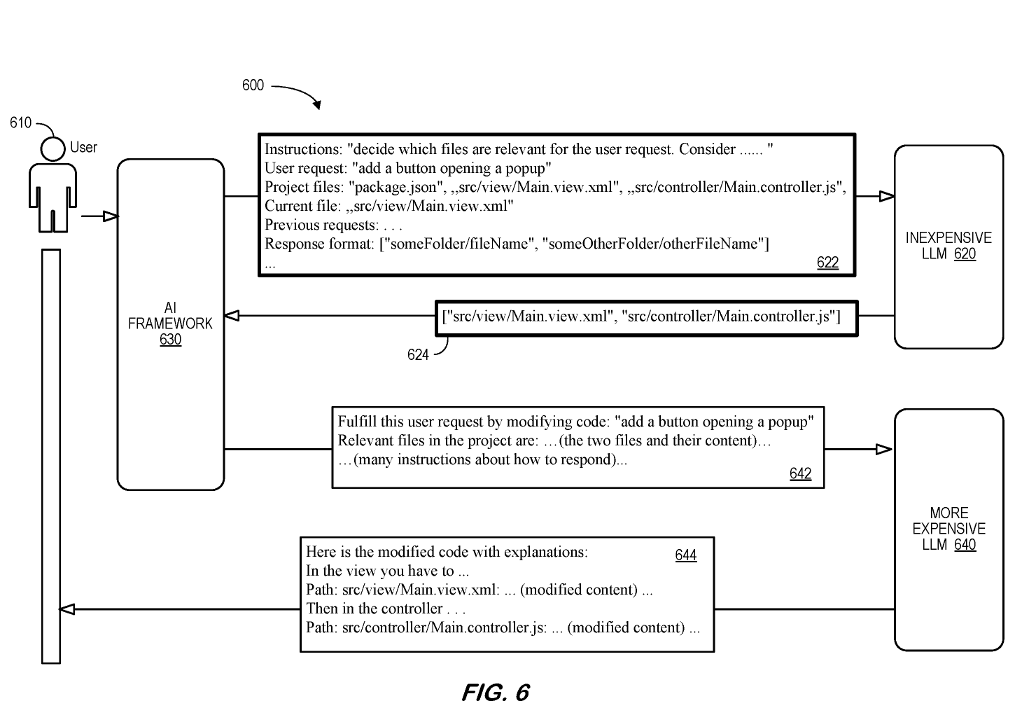

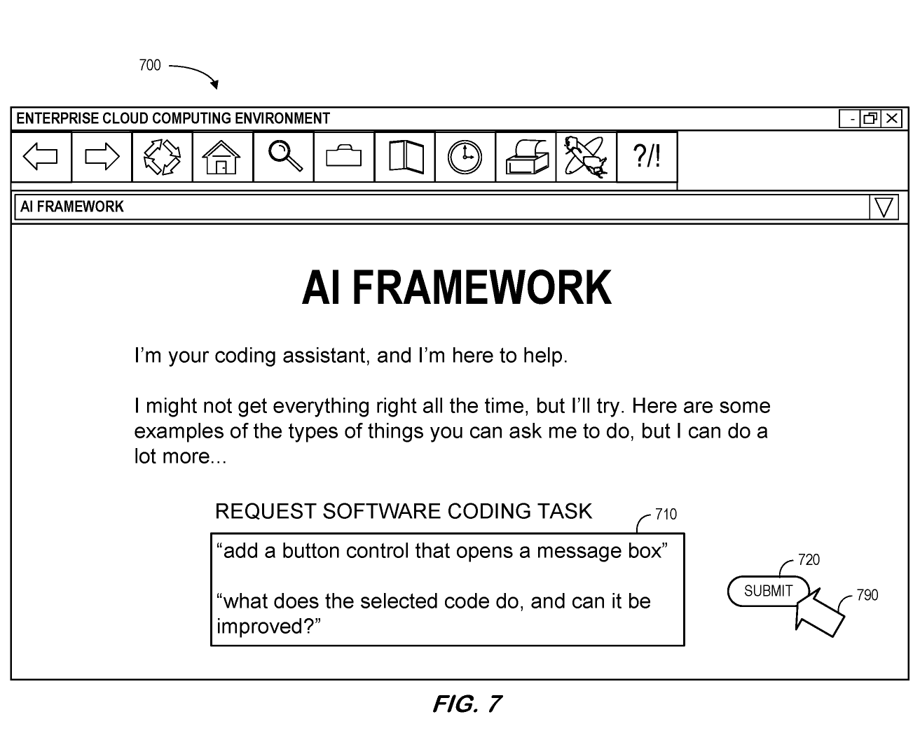

FIG. 6 is an information flow 600 associated with user requests to perform a software task according to some embodiments. A user 610 provides a first request to a context enhancement platform 630. For example, FIG. 7 is a User Interface (“UI”) 700 for an AI framework in accordance with some embodiments. The UI 700 includes a request text entry area 710 that can be used to send then the request via a “Submit” icon 720 selected via a computer mouse pointer 790.

Referring again to FIG. 6, the context enhancement platform 630 uses the request to create a prompt for a first query 622 for a relatively inexpensive LLM 620. The prompt for the first query 622 might include a list of project file names and be designed to select (from a user data store) the items that are most relevant to the user request. The prompt of the first query 622 might contain, for example: the text original user request; the list of files (e.g., file names and paths) in the project, potentially filtered to remove irrelevant information; the name of the file that the user is currently looking at (for better context and for situations in which the user 610 says “here” or “in this file”); the code that is currently selected (if any); instructions about how to decide which files might be needed; etc. This information might be technology-specific (e.g., the inexpensive LLM 620 might be reminded that adding new modules in code also requires adding dependencies or configurations in certain other files). In some embodiments, a history of previous user requests may be available to give further context when the user 610 refers to prior interactions. Moreover, the first prompt might include information about the exact format that the inexpensive LLM 620 should use to create a response (e.g., it must be a JSON format that contains an array of all relevant file names, including their full path within the project).

The inexpensive LLM 620 provides a response 624 to query 622 listing the most relevant items (e.g., “main.view.xml” and “main.controller.js” in the example of FIG. 6). This is used by the context enhancement platform 630 to create a second prompt 642, including the user query and the list of most relevant items, that is sent to a more expensive LLM 640. A response 644 to that second prompt can then be transmitted back to the user 610.

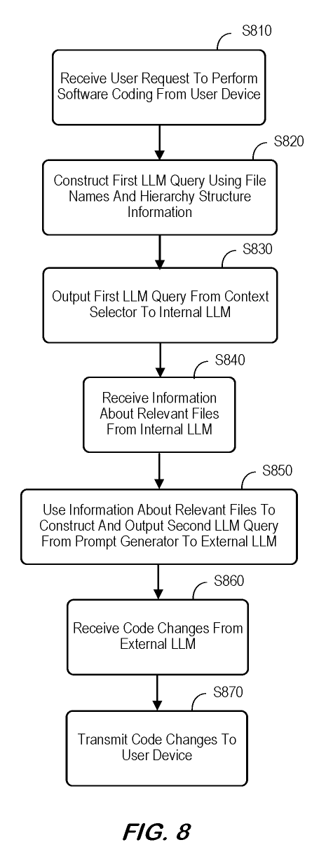

FIG. 8 is an “end-to-end” method according to some embodiments. At S810, a user request to perform software coding is received from a user device. At S810, the system receives a user request to perform software coding from a user device. At S820, the system constructs a first LLM query using file names and/or hierarchy structure information of a user data store. Embodiments may benefit from the fact that in coding projects certain aspects are usually handled in specific files. For example, when a TypeScript configuration needs to be changed this might happen in a “tsconfig” file while dependencies are maintained in a “package.json” file. Similarly, functionality for controls in a view are implemented in a “controller” file with the same file name, etc. Also, file names of project-specific files are typically indicative of what the file is doing. LLMs have broad training and are good in making logical connections independently from the concrete project type or even the programming language.

For example, when a user asks the system to “add a button that opens a popup,” the first request is created listing the project’s files (including “app.view.xml,” “main.view.xml,” and “main.controller.js” along with information indicating that the user currently looks at “main.view.xml” in the active tab. At S830, the system outputs a first LLM query from a context selector to an internal LLM, and information about relevant files is received from the internal LLM at S840.

The internal LLM deduces that the button should be added to the currently open “main.view.xml” (not the other view) and knows that the popup opening functionality should be in the controller that belongs to this view (“main.controller.js”). A button is simple control, so it is likely that no additional dependency is needed. Hence, the internal LLM responds to the first request stating that the files “main.view.xml” and “main.controller.js” are needed. When a more exotic UI element is requested by the user, the internal LLM would probably decide to add the file(s) containing the project dependencies to the list (so that in a second LLM call it can be checked to see if the exotic UI element is available already or whether a new dependency needs to be added). At S850, information about relevant files is used to construct and output a second LLM query from a prompt generator to an external LLM. At S860, the system receives code changes from the external LLM. Finally, the code changes are transmitted to the user device at S870.

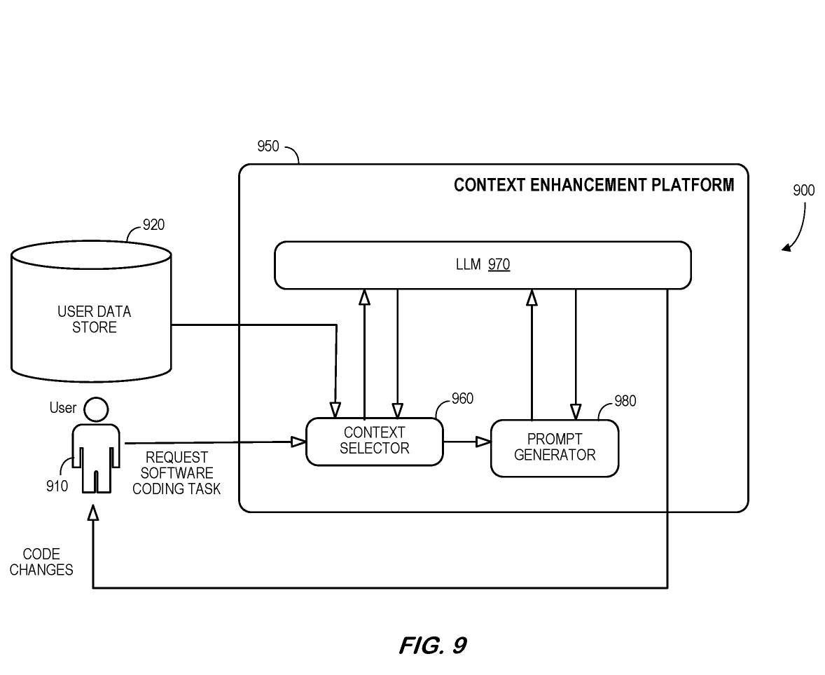

Note that embodiments could be implemented in any of a number of different configurations. For example, FIG. 9 is a system 900 associated with a single LLM in accordance with some embodiments. As before, a context enhancement platform 950 receives a user request (a requesting a software coding task) from a user 910. The user request is associated with files stored in a user data store 920 (along with file names arranged in a file hierarchy). A context selector 960 receives the user request and determines information about files in the user data store 920. The context selector 960 then creates a prompt based on the user request and information about the files in the user data store 920 (e.g., the list of file names and/or the file hierarchy). The prompt is then submitted to an LLM 970 which responds with information about which files are likely to be relevant to the user request. This information is provided to a prompt generator 90 along with the user request. The prompt generator 980 constructs a prompt with the relevant context information and submits it to the same LLM 970. The external LLM 970 can then generate an appropriate response to the user request.

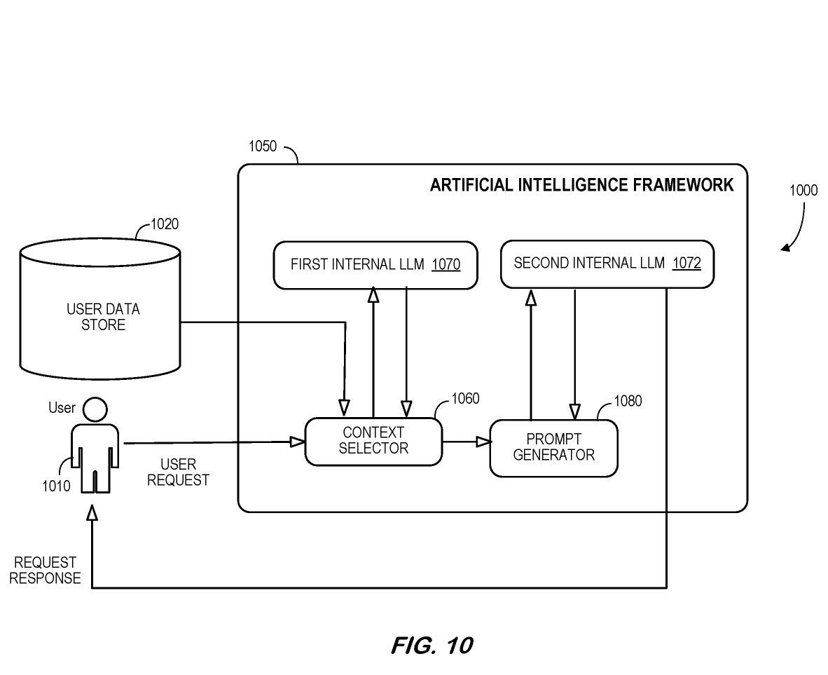

As another example, FIG. 10 is a system 1000 associated with multiple internal LLMs according to some embodiments. In this embodiment, an AI framework 1050 receives a user request from a user 1010. The user request is associated with items stored in a user data store 1020 (along with item identifiers). A context selector 1060 receives the user request and determines information about items in the user data store 1020. The context selector 1060 creates a prompt based on the user request and information about the items in the user data store 1020 (e.g., a list of item identifiers). The prompt to submitted to a first internal LLM 1070 (e.g., internal to the AI framework 1050) which responds with information about which items may be relevant to the user request. This information is provided to a prompt generator 1080 along with the user request. The prompt generator 1080 constructs a prompt with the relevant context information and submits it to a second internal LLM 1072. The second internal LLM 1072 then generates an appropriate response to the user request.

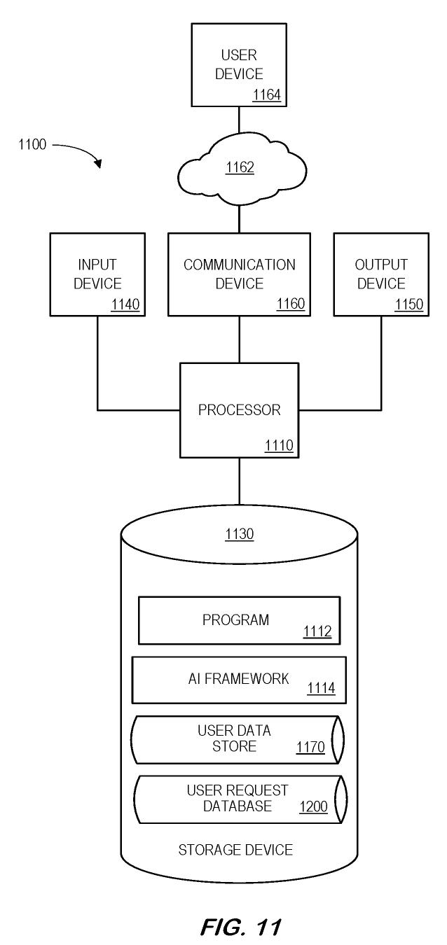

Embodiments described herein may be implemented using any number of different hardware configurations. For example, FIG. 11 is a block diagram of an apparatus or platform 1100 that may be, for example, associated with the system 400 of FIG. 4 (and/or any other system described herein). The platform 1100 comprises a processor 1110, such as one or more commercially available Central Processing Units (“CPUs”) in the form of one-chip microprocessors, coupled to a communication device 1160 configured to communicate via one or more communication networks. The communication device 1160 may be used to communicate, for example, with one or more user devices 1164 via a distributed computer network 1162. The platform 1100 further includes an input device 1140 (e.g., a computer mouse and/or keyboard to input data source information, file dependency rules or logic, etc.) and an output device 1150 (e.g., a computer monitor to render a display, transmit recommendations, charts, alerts, reports about user request responses, etc.).

The processor 1110 also communicates with a storage device 1130. The storage device 1130 may comprise any appropriate information storage device, including combinations of magnetic storage devices (e.g., a hard disk drive), optical storage devices, mobile telephones, and/or semiconductor memory devices. The storage device 1130 stores a program 1112 and/or AI framework 1114 for controlling the processor 1110. The processor 1110 performs instructions of the programs 1112, 1114, and thereby operates in accordance with any of the embodiments described herein. For example, the processor 1110 may access items, each item containing an item identifier. The items might comprise, for example, files and file names arranged in a hierarchy. The processor 1110 may then receive a user request from a user device. The processor 1110 constructs and outputs a first LLM query, from a context selector to a first LLM. The first LLM query may be, for example, designed to select relevant items from the user data store. Based on a response to the first LLM query, the processor 1110 constructs and outputs a second LLM query, from a prompt generator to a second LLM. The second LLM query may, according to some embodiments, include information about the user request and information about the relevant items.

The programs 1112, 1114 may be stored in a compressed, uncompiled and/or encrypted format. The programs 1112, 1114 may furthermore include other program elements, such as an operating system, clipboard application, a database management system, and/or device drivers used by the processor 1110 to interface with peripheral devices.

As used herein, information may be “received” by or “transmitted” to, for example: (i) the platform 1100 from another device; or (ii) a software application or module within the platform 1100 from another software application, module, or any other source.

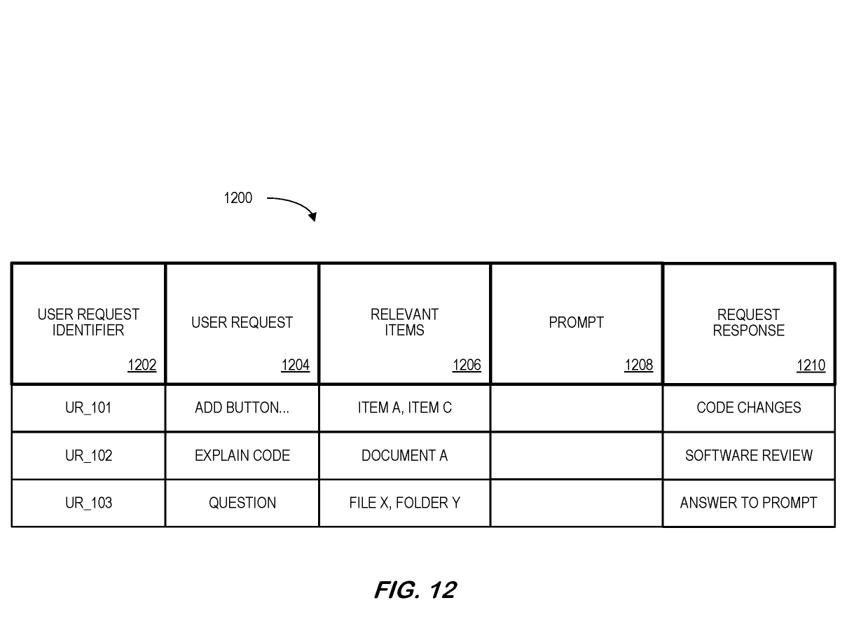

In some embodiments (such as the one shown in FIG. 11), the storage device 1130 further stores the user data store 1170 (e.g., containing software program files) and the user request database 1200. An example of a database that may be used in connection with the platform 1100 will now be described in detail with respect to FIG. 12. Note that the database described herein is only one example, and additional and/or different information may be stored therein. Moreover, various databases might be split or combined in accordance with any of the embodiments described herein.

Referring to FIG. 12, a table is shown that represents the user request database 1200 that may be stored at the platform 1100 according to some embodiments. The table may include, for example, entries identifying user queries. The table may also define fields 1202, 1204, 1206, 1208, 1210 for each of the entries. The fields 1202, 1204, 1206, 1208, 1210 may, according to some embodiments, specify: a user request identifier 1202, a user request 1204, relevant items 1206, prompt 1208, and request response 1210. The user request database 1200 may be created and updated, for example, when new user requests are received, an internal LLM determines relevant items, etc.

The user request identifier 1202 might be a unique alphanumeric label for a coding request received from a user. The user request 1204 might contain the text of the actual user request (e.g., “write code to perform this specific function”). The relevant items 1206 might comprise a list of item identifiers, document or file names, etc. that are likely to be relevant to the user request 1204 based on a response to an initial LLM prompt (e.g., the initial LLM prompt including the item identifiers and relationships between items, such as an item hierarchy). The prompt 1208 includes the final LLM request including the user request 1204 and information about the relevant items 1206. The request response 1210 is the final request provided back to the user (e.g., software code changes).

In this way, embodiments may facilitate reduced context size resulting in cost savings and the results of an improved LLM focus. Cost reduction may also be achieved by shifting the computing load from more expensive LLMs (used for actual code generation responding to the user request) to a cheaper LLM (for an initial request to determine relevant information). Because the context is now relevant to the actual user request, embodiments may result in better answers. Moreover, confidential and irrelevant files are not sent to the final LLM, even if they are accidentally opened by the user. Embodiments may be achieved with reduced complexity by using already available LLM infrastructure (as compared to RAG approaches which typically need a separate database and preprocessing of the content).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of use cases, any of the embodiments described herein could be applied to other types of use cases.

Note that the invention could be applied in other domains than coding assistance, as long as the folder structure and/or file names provide enough information to decide whether they are relevant. The invention could be applied in both direct user-interaction (responding to human input) as well as for automated agents. In some embodiments, the content of the files may be indexed (e.g., summarized using LLM requests) to allow for a decision that takes concrete content into account.

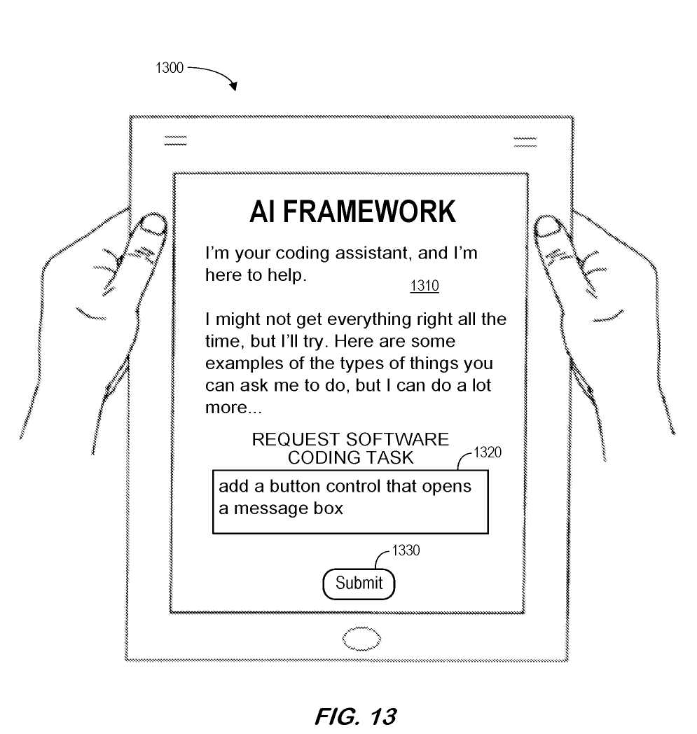

In addition, the displays shown herein are provided only as examples, and any other type of user interface could be implemented. For example, FIG. 13 illustrates a tablet computer 1300 providing an AI framework display 1310 according to some embodiments. The display 1310 might be used, for example, to help respond to software coding requests from engineers for an enterprise. A user may interact with the display 1310, such as via a request text entry area 1320 and a “Submit” icon 1330 (e.g., to ask for a coding task, software review comments and suggestions, etc.).

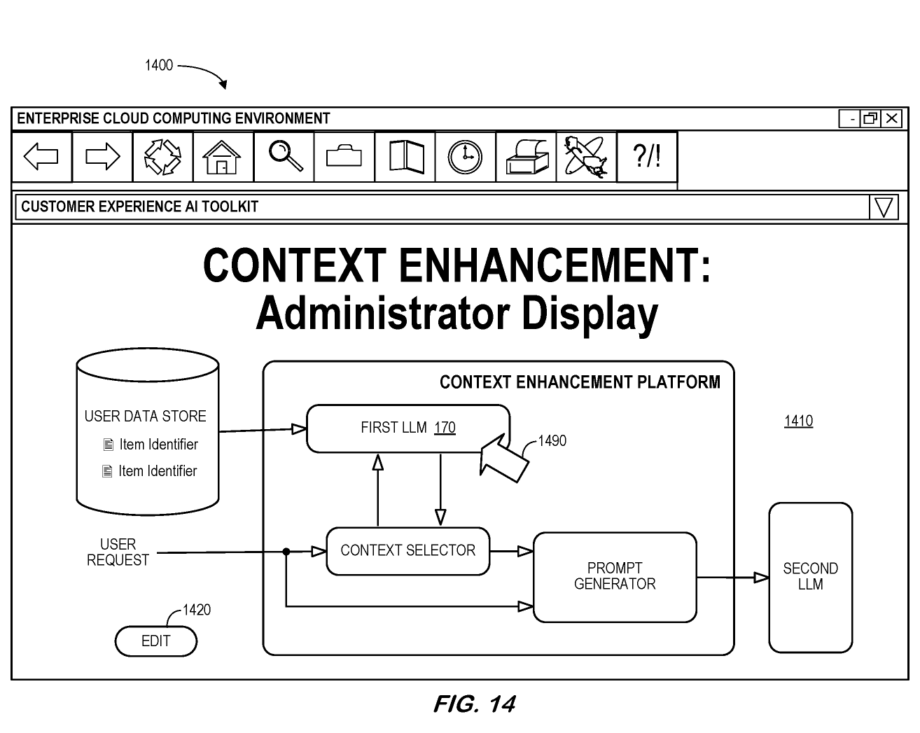

FIG. 14 is a context selection AI framework display 1400 in accordance with some embodiments. The display 1400 includes a graphical representation 1410 of an AI framework in accordance with any of the embodiments described herein. Selection of an element on the display 1400 (e.g., via a touchscreen or computer pointer 1490) may result in display of a pop-up window containing more detailed information about that element and/or various options (e.g., to define how a data source interacts with the toolkit, how users communicate with the toolkit, etc.). Selection of an “Edit” icon 1420 may also let an operator or administrator adjust the operation of the system (e.g., to change a mapping to a data store, adjust LLM parameters, make changes to internal LLMs, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system, comprising:
a user data store containing items, each item containing an item identifier; and
a context enhancement platform, coupled to the user data store, including:
a computer processor, and
a computer memory storing instructions that when executed by the computer processor cause the context enhancement platform to:
receive a user request from a user device,
construct and output a first Large Language Model (“LLM”) query, from a context selector to a first LLM, the first LLM query being designed to select relevant items from the user data store, and
based on a response to the first LLM query, construct and output a second LLM query, from a prompt generator to a second LLM, the second LLM query including information about the user request and information about the relevant items.

2. The system of claim 1, wherein information about a response to the second LLM is transmitted to the user device.

3. The system of claim 1, wherein the items are documents and the item identifiers are document titles.

4. The system of claim 3, wherein the documents comprise files and the document titles are file names.

5. The system of claim 1, wherein the items in the user data store are arranged in a hierarchy and the first LLM query is further based on information about the hierarchy.

6. The system of claim 1, wherein the user request is a request to perform a software coding task, and the context enhancement platform is associated with an Artificial Intelligence (“AI”) coding assistant.

7. The system of claim 6, wherein the second LLM query is further based on at least one of: (i) a user selected code portion, and (ii) user selected open code window tabs.

8. The system of claim 7, wherein the second LLM query includes information about at least one of the following: (i) a user request history, (ii) instructions about how the items interact, and (iii) a requested output format.

9. The system of claim 1, wherein the user device is associated with an automated Artificial Intelligence (“AI”) agent.

10. The system of claim 1, wherein the first and second LLM comprise a single LLM.

11. The system of claim 1, wherein the second LLM is a different model than, and independent of, the first LLM.

12. The system of claim 11, wherein the first LLM is internal to the context enhancement platform and the second LLM is external to the context enhancement platform.

13. The system of claim 1, wherein the user data store contains a user table and the items are portions of the user table.

14. A computer-implemented method, comprising:
receiving, at a computer processor of a context enhancement platform, a user request from a user device;
constructing and outputting a first Large Language Model (“LLM”) query, from a context selector to an internal LLM, the first LLM query being designed to select relevant files names in a user data store, the user data store containing coding files with each file containing a file name;
based on a response to the first LLM query, constructing and outputting a second LLM query, from a prompt generator to an external LLM, the second LLM query including information about the user request and information about the relevant coding files; and
arranging for information about a response to the second LLM query to be transmitted to the user device.

15. The method of claim 14, wherein the coding files in the user data store are arranged in a hierarchy and the first LLM query is further based on information about the hierarchy.

16. The method of claim 15, wherein the user request is a request to perform a software coding task, and the context enhancement platform is associated with an Artificial Intelligence (“AI”) coding assistant.

17. The method of claim 16, wherein the second LLM query is further based on at least one of: (i) a user selected code portion, and (ii) user selected open code window tabs.

18. The method of claim 14, wherein the internal and external LLMs comprise one of: (i) a single LLM, and (ii) an external LLM different than, and independent of, the internal LLM.

19. One or more non-transitory computer-readable media storing computer-executable instructions that, when executed by a computing system, cause the computing system to perform operations, comprising:
receiving, at a computer processor of a context enhancement platform, a user request from a user device;
constructing and outputting a first Large Language Model (“LLM”) query, from a context selector to an internal LLM, the first LLM query being designed to select relevant files names in a user data store, the user data store containing coding files with each file containing a file name;
based on a response to the first LLM query, constructing and outputting a second LLM query, from a prompt generator to an external LLM, the second LLM query including information about the user request and information about the relevant coding files; and
arranging for information about a response to the second LLM query to be transmitted to the user device.

20. The media of claim 19, wherein information about a response to the second LLM is transmitted to the user device.

21. The media of claim 20, wherein the second LLM query includes information about at least one of the following: (i) a user request history, (ii) instructions about how the coding files interact, and (iii) a requested output format.
